(19) United States
(12) Patent Application Publication
(10) Pub. No.: US 2005/0158418 A1
(43) Pub. Date: Jul. 21, 2005

(54) Forming apparatus

(75) Inventor: Tatsuya Suzuki, Tokyo (JP)

Correspondence Address: HOGAN & HARTSON L.L.P., 500 S. GRAND AVENUE, SUITE 1900, LOS ANGELES, CA, 90071-2611, US

(73) Assignee: OLYMPUS CORPORATION

(21) Appl. No.: 11/065,771

(22) Filed: Feb. 24, 2005

Related U.S. Application Data
(63) Continuation of application No. PCT/JP05/01159, filed on Jan. 21, 2005.

(30) Foreign Application Priority Data
Jan. 21, 2004 (JP) 2004-013241

(51) Int. Cl. B29C 43/22

(52) U.S. Cl. 425/150; 425/347

(57) ABSTRACT

A forming apparatus includes a punching unit that punches a wood of a formed object in a predetermined shape, a first die that has a guide hole for guiding the punching unit and performs compression forming of the wood, a second die that forms a pair with the first die to perform the compression forming of the wood, and a drive controller that relatively brings the punching unit close to the second die to punch the wood in the predetermined shape while moving one of the first die and the second die toward the other one of the first die and the second die to perform the compression forming of the wood.

### CROSS-REFERENCE TO RELATED APPLICATIONS

The present application is a continuation of PCT/JP2005/001159 filed on Jan. 21, 2005, which claims priority to Japanese Patent Application No. 2004-013241, filed on Jan, 21, 2004.

### BACKGROUND OF THE INVENTION

1) Field of the Invention

The present invention relates to a forming apparatus that can easily and accurately perform blanking or punching to a compressed wood.

2) Description of the Related Art

Examples of portable electric equipment that can be operated on hand include a camera, a mobile communication device (mainly cellular phone), an IC recorder, a PDA, a portable television, a portable radio, and remote controls for various home appliances. Usually, synthetic resins (ABS, polycarbonate, acrylic, and the like) and light metals (aluminum, stainless steel, titanium, magnesium, and the like) are used as the portable electronic equipment exterior material due to industrial mass production. Such the synthetic resins and light metals constituting the exterior material are oriented to industrial products while appropriate strength is obtained, so that there is no individual difference in appearance. Further, in the synthetic resins and the light metals constituting the exterior material, a flaw and discoloration are generated in long-term use. However, the flaw and the discoloration only impair the worth of the electronic equipment.

Therefore, it is thought that one may use wood which is of a natural raw material as the exterior material. Because the wood has various kinds of grain, the wood has the individual difference and individuality. Although the flaw and a change in color shade are generated in the long-term use in the wood, they become the unique feel and texture of the wood to cause users to feel an affinity.

However, when the wood is three-dimensionally processed for the exterior material, there is a fear for strength of the wood. Specifically, in the exterior material made of wood, when the same strength as that of the synthetic resins or the light metals is demanded, since the increase in thickness of the wood is required, the wood is not suitable for the exterior material of the portable electronic equipment. On the other hand, in the exterior material made of wood, when the same size as that of the exterior material formed of the synthetic resins or the light metals is demanded, the strength is decreased because the thickness is made smaller. Therefore, in the conventional art, there is a technology in which the strength is obtained by compressing the wood as described below.

A conventional method is well known in which the wood softened by absorbing moisture is compressed and held to fix a shape, then is sliced in a compression direction to obtain a plate-shaped primary fixed product, the primary fixed product is formed in a formed product having a predetermined three-dimensional shape while heated and absorbed, and the shape of the formed product is fixed to obtain a secondary fixed product (for example, Japanese Patent No. 3078452).

A conventional method is well known, in which a woody material compressed in a state in which the softening treatment is performed is temporarily fixed and then is recovered in a form to perform forming, as a method of three-dimensionally processing the woody material (for example, Japanese Patent Application Laid-Open No. 11-77619).

### SUMMARY OF THE INVENTION

It is an object of the present invention to at least solve the problems in the conventional technology.

A forming apparatus according to one aspect of the present invention includes a punching unit that punches a wood of a formed object in a predetermined shape; a first die that has a guide hole for guiding the punching unit and performs compression forming of the wood; a second die that forms a pair with the first die to perform the compression forming of the wood; and a drive controller that relatively brings the punching unit close to the second die to punch the wood in the predetermined shape while moving one of the first die and the second die toward the other one of the first die and the second die to perform the compression forming of the wood.

A forming apparatus according to another aspect of the present invention includes a first die that performs compression forming of a wood of a formed object, a punching unit that is guided along a periphery of the first die and blanks the wood in a predetermined shape, a second die that forms a pair with the first die to perform the compression forming of the wood, and a drive controller that relatively brings the punching unit close to the second die to blank the wood in the predetermined shape while moving one of the first die and the second die toward the other one of the first die and the second die to perform the compression forming of the wood.

### BRIEF DESCRIPTION OF THE DRAWINGS

FIG. 1 is a sectional view that depicts electronic equipment in which a compressed wood made by a forming apparatus according to an embodiment of the invention is used as an exterior material;

FIG. 2 is a perspective view that depicts shape taking of an object wood formed in the compressed wood;

FIG. 3 is a view that explains a schematic process of producing the compressed wood formed by a first embodiment of the invention;

FIG. 4 is a view that depicts a control position relationship between a moving-side die and a punch;

FIG. 5 is a view that depicts another control position relationship between the moving-side die and the punch;

FIG. 6 is a view that depicts still another control position relationship between the moving-side die and the punch;

FIG. 7 is a perspective view that depicts a shape of a rectangular blade portion;

FIG. 8 is a bottom view of the rectangular blade portion;

FIG. 9 is a front elevation of a circular blade portion;

FIG. 10 is a bottom view of the circular blade portion;

FIG. 11 is a view that depicts another example of the shape taking; and

FIG. 12 is a view that explains the schematic process of producing the compressed wood formed by a second embodiment of the invention.

### DETAILED DESCRIPTION

Exemplary embodiments of a forming apparatus relating to the present invention will be explained in detail below with reference to the accompanying drawings.

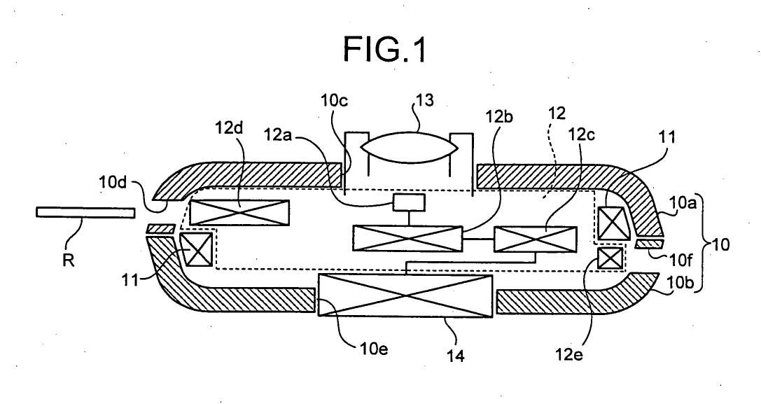

FIG. 1 is a sectional view that depicts an electronic equipment in which a compressed wood made by a forming apparatus according to an embodiment of the invention is used as an exterior material. In FIG. 1, a digital camera is shown as an example of the electronic equipment. The digital camera has a reinforcing frame 11 and an inner mechanism 12 inside an exterior material 10 formed by the compressed wood product. The digital camera also has an image taking lens 13 and a liquid crystal monitor 14 while the image taking lens 13 and the liquid crystal monitor 14 are exposed to the outside of the exterior material 10. The inner mechanism 12 includes an image pickup device 12a such as a CCD, a drive circuit 12b that drives the image pickup device 12a, a drive circuit 12c that drives the liquid crystal monitor 14, a recording device 12d for an image recording medium R, and a connection terminal 12e connected to an external personal computer.

The exterior material 10 includes a front cover 10a and a rear cover 10b. A lens hole 10c is made in a main plate portion of the front cover 10a so that the image taking lens 13 is projected outside of the front cover 10a. The lens hole 10c is made corresponding to an outer shape of a holding portion that holds the image taking lens 13. For example, when the holding portion has a cylindrical shape, the lens hole 10c is made in a circular shape so that the holding portion is projected outside of the front cover 10a. An aperture 10d is provided in a side plate portion of the front cover 10a so that the image recording medium R is inserted into or extracted from the aperture 10d. A rectangular window 10e is made in the main plate portion of the rear cover 10b so that the liquid crystal monitor 14 is exposed outside of the rear cover 10b. An aperture 10f is provided in the side plate portion of the rear cover 10b so that a connection cable connected to the connection terminal 12e is inserted into or extracted from the aperture 10f. In addition, although not shown in the drawings, button holes are made in the front cover 10a and the rear cover 10b so that various operation buttons for operating the digital camera are exposed. A cover and the like may be provided in the button hole if needed.

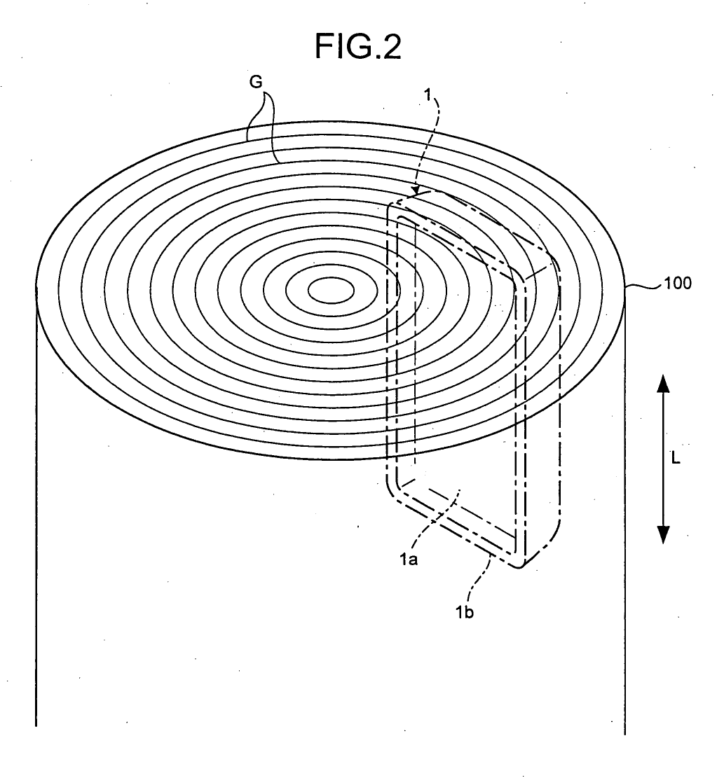

FIG. 2 is a perspective view that depicts shape taking of an object wood to be formed into the compressed wood. As shown in FIG. 2, the compressed wood product constituting the exterior material 10 is made by compressing a wood 1. The shape of the wood 1 is taken from a raw material 100 before the wood 1 is compressed. Examples of the raw material 100 include Japanese cypress (hinoki, hiba), paulownia (kiri), teak, mahogany, Japanese cedar, pine, and cherry. The wood 1 is a lump including a main plate portion 1a having a predetermined shape (substantially rectangular shape in this case) and a side plate portion 1b that is provided while vertically rising from a periphery of the main plate portion 1a. The main plate portion 1a forms the main plate portion of the front cover 10a or the rear cover 10b, and the side plate portion 1b forms the side plate portion of the front cover 10a or the rear cover 10b. In the wood 1, the main plate portion 1a and the side plate portion 1b are formed so as to couple to each other in a smooth curved surface. Particularly it is preferable that a lengthwise direction of the shape of the main plate portion 1a is taken along a fiber direction L.

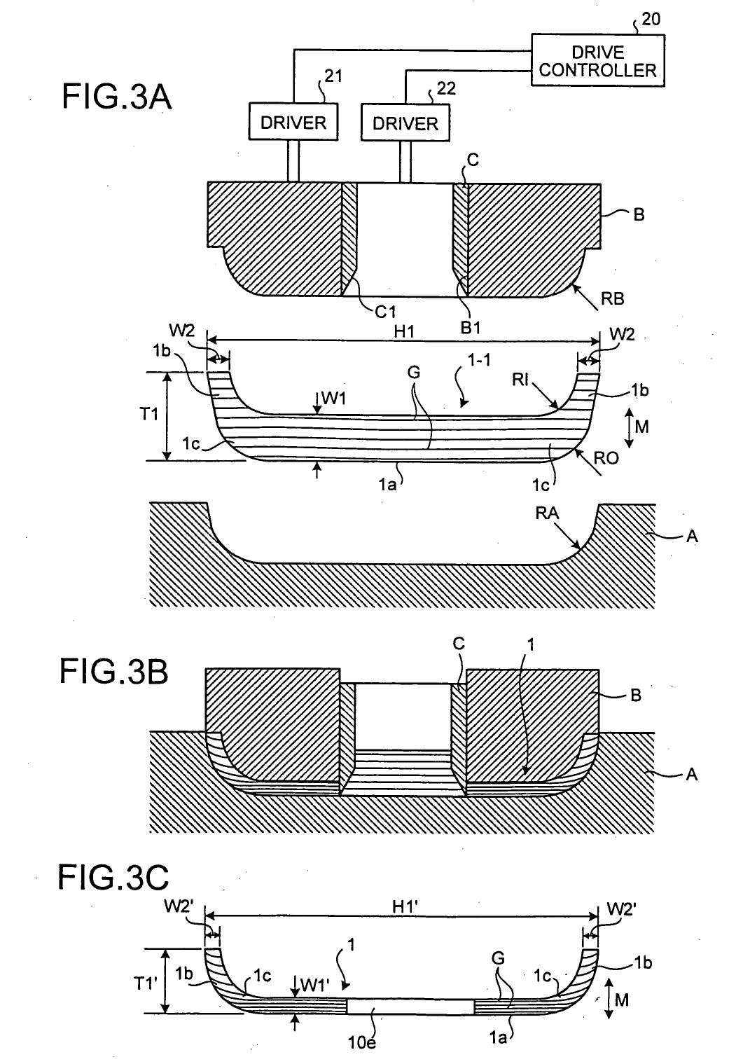

FIG. 3 is a view that explains a schematic process of producing the compressed wood formed by a first embodiment of the invention. The shape of the wood 1 is taken while a volume decreased by the compression is previously added. Specifically, as shown in FIG. 3A, the shape of the main plate portion 1a is taken with a thickness W1 in which the volume decreased by the compression is previously added. The shape of the side plate portion 1b is taken with a thickness W2 and a height T1 in which the volume decreased by the compression is previously added. The shape of the wood 1 is taken with a total width H1. The thickness W1 of the main plate portion 1a is formed larger than the thickness W2 of the side plate portion 1b. A middle portion between the main plate portion 1a and the side plate portion 1b is formed in the smooth curve so that the thickness W1 of the main plate portion 1a is gradually changed to the thickness W2 of the side plate portion 1b. The side plate portion 1b is formed so as to rise obliquely outward from the main plate portion 1a. In the wood 1, FIG. 3 shows the shape of either the front cover 10a or the rear cover 10b in the exterior material 10 formed of the compressed wood. The shape of the other one of the front cover 10a and the rear cover 10b is similar to the shape of one shown in FIG. 3.

The wood 1 is compressed between a fixed-side die A and a moving-side die B. As shown in FIG. 3A, the fixed-side die A has a concave surface that hits against a curved outside surface (lower surface in FIG. 3). In the curved outside surface, the side plate portion 1b rises from the main plate portion 1a of the wood 1. The concave surface of the fixed-side. die A has the shape to which the outside surface of the wood 1 is fitted. The radius of. curvature of a curved surface RO at the outside surface of the wood 1 and the radius of curvature of a curved surface RA at the fixed-side die A that is opposite to the curved surface RO have a correlation of RO>RA. On the other hand, the moving-side die B has a convex surface that hits against a curved inside surface (upper surface in FIG. 3). In the curved inside surface, the side plate portion 1b rises from the main plate portion 1a of the wood 1. The convex surface of the moving-side die B has the shape to which the inside surface of the wood 1 is fitted. The radius of curvature of a curved surface RI at the inside surface of the wood 1 and the radius of curvature of a curved surface RB at the moving-side die B that is opposite to the curved surface RI have the correlation of RI>RB. After the fixed-side die A and the moving-side die B are combined, namely after the wood 1 is compressed, a space formed between the concave surface of the fixed-side die A and the convex surface of the moving-side die B has the shape of post-compression of the wood 1 (see FIG. 3B).

The moving-side die B has a guide hole B1 for guiding a punch C. The guide hole B1 is provided at a position corresponding to the window 10e, and the guide hole B1 is a prismatic space that has a rectangular sectional shape corresponding to the window 10e. The punch C punches out the window 10e, and a blade portion C1 is formed facing a fixed-side die A, namely at a leading end of the punch C. A driver 21 drives the moving-side die B, a driver 22 drives the punch C, and a drive controller 20 controls the drive of each of the drivers 21 and 22. At this point, the drivers 21 and 22 are independently controlled, which allows the moving-side die B and the punch C to be independently driven. Thus, the forming apparatus includes the drive controller 20, the drivers 21 and 22, the moving-side die B, the punch C, and the fixed-side die A.

The wood 1 shown in FIG. 3A is placed in a water vapor atmosphere at high temperature and high pressure. When the wood 1 is placed in the water vapor atmosphere at high temperature and high pressure for a predetermined time, the wood 1 is softened by excessively absorbing moisture. In the water vapor atmosphere at high temperature and high pressure, the wood 1 is arranged between the fixed-side die A and the moving-side die B with the punch C, and the wood 1 is arranged on the concave surface of the fixed-side die A. At this point, the main plate portion 1a in the wood 1 has a flat-grain surface, so that the wood 1 has the mode in which a direction M, in which the pieces of grain G are laminated, exists in a horizontal direction of FIG. 3 and the fiber direction L exists along a depth direction of FIG. 3.

Then, as shown in FIG. 3B, the wood 1 is compressed by bringing the moving-side die B close to the fixed-side die A. Namely, the convex surface of the moving-side die B is fitted into the concave surface of the fixed-side die A. In the wood 1 sandwiched between the fixed-side die A and the moving-side die B, compressive force is applied to the main plate portion 1a in a thickness W1 direction (direction M in which pieces of grain G are laminated), and the compressive force is also applied to the main plate portion 1a in the direction intersecting (orthogonal to) the fiber direction L. In the wood 1, the compressive force is applied to the side plate portion 1b in a thickness W2 direction (direction along the grain G) and in a height T1 direction (direction M in which pieces of grain G are laminated), and the compressive force is also applied to the side plate portion 1b in the direction intersecting (orthogonal to) the fiber direction L. Further, in the wood 1, the compressive force is applied to a curved portion 1c that couples the main plate portion 1a and the side plate portion 1b in the direction M in which the pieces of grain G are laminated and in the direction along the grain G, and the compressive force is also applied to the curved portion 1c in the direction along the fiber direction L. Specifically, the curved portion 1c is formed so that the side plate portion 1b rises obliquely outward, and the radii of curvature of the fixed-side die A and the moving-side die B have the relationship described above. Therefore, the compressive force is applied upward to the outside surface of the curved portion 1c, and the compressive force is applied downward to the inside surface. Then, the wood 1 is left for a predetermined time while the compressive force is applied to the wood 1.

At this point, the punch C and the moving-side die B are simultaneously lowered. The compressive force is not applied to an area that is punched out by the punch C, namely a portion corresponding to the window 10e, and the portion corresponding to the window 10e is cut by the blade portion C1 of the punch C.

Finally, after the wood 1 is left for the predetermined time, the water vapor atmosphere at high temperature and high pressure is released, the moving-side die B is separated from the fixed-side die A, and the compressed wood 1 is taken out as shown in FIG. 3C. In the compressed wood 1 taken out from between the fixed-side die A and the moving-side die B, the wood 1 is compressed to substantially even thicknesses W1′ and W2′ at the main plate portion 1a and the side plate portion 1b, respectively. In the compressed wood 1, the side plate portion 1b is compressed to a height T1′. In the compressed wood 1, the curved portion 1c which couples the main plate portion 1a and the side plate portion 1b is compressed so that the grain G is deformed in the oblique direction. The compressed wood 1 is slightly compressed to a width H1′. Further, the window 10e is simultaneously formed by the punch C. At this point, because the punch C cuts the wood halfway through the compression, the crack and the like are not generated in a periphery of the window 10e formed after the compression, and the window 10e is easily formed with high accuracy. Because the punch C is guided to perform the punching at the same time as the compression forming, it is not necessary to perform alignment, and the forming is rapidly and easily performed, when compared with the case in which the punching is separately performed to the wood after the compression forming.

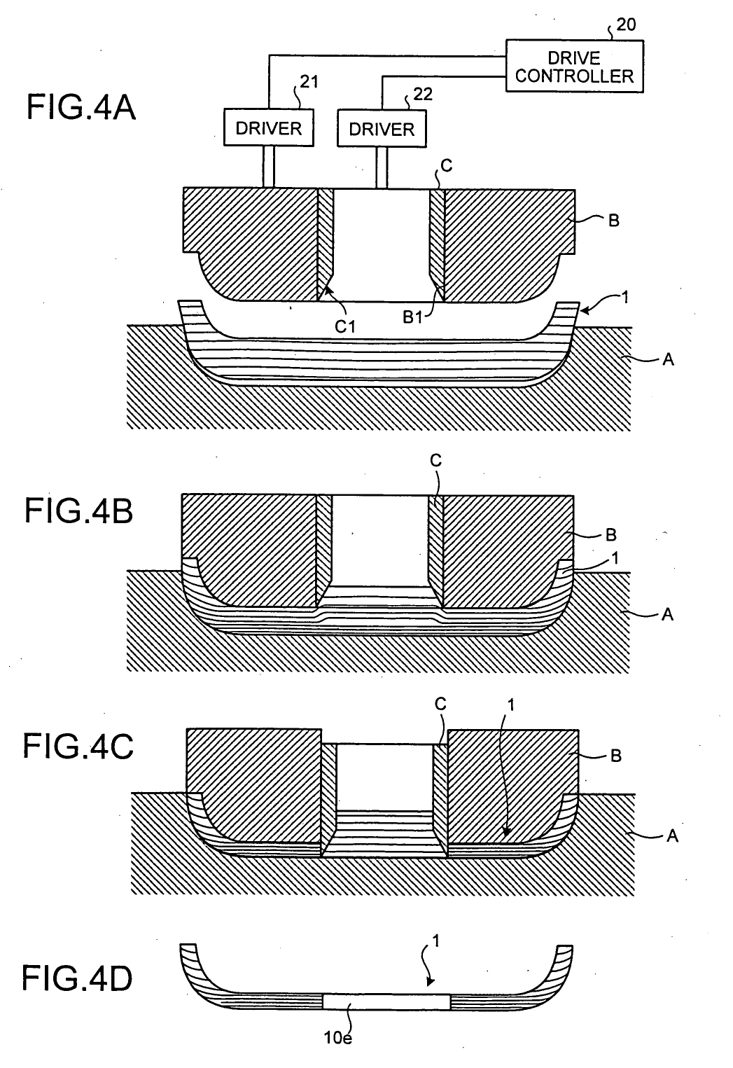

FIG. 4 is a view that depicts a relationship between the moving-side die B and the punch C. As described above, when the wood 1 is compressed, the punch C is fitted into the guide hole B1 of the moving-side die B, and the leading end of the blade portion C1 is moved downward, namely toward the fixed-side die A while corresponding to a bottom portion of the moving-side die B. Such downward movement allows the moving-side die B to compress the wood 1 and the punch C to perform the punching of the window 10e. The punch C is moved downward until the punch C abuts on the fixed-side die A. As a result, the punching of the window 10e is completed.

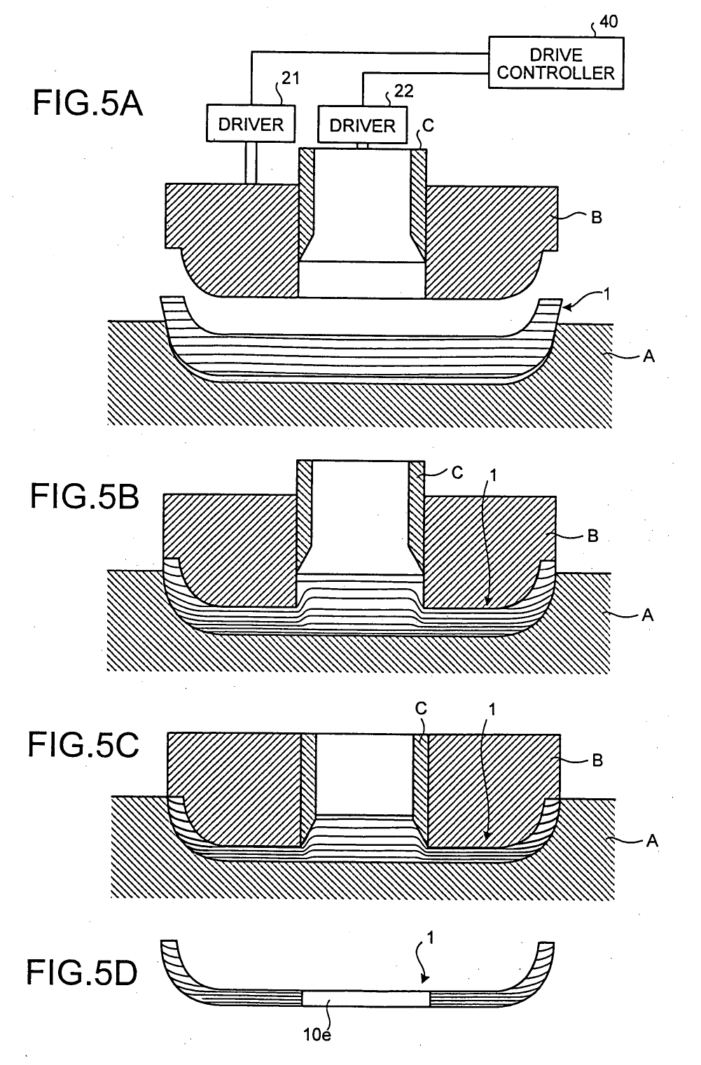

The movement of the punch C is substantially equal to the movement of the moving-side die B in FIG. 4. However, as shown in FIG. 5, it is possible that the punch C is moved slightly behind the movement of the moving-side die B and the wood is cut at a high-speed stroke. In this case, it is preferable that the drive controller 40 controls the drive of the punch C so that the leading end of the punch C corresponds to the bottom portion of the moving-side die B when a distance between the punch C and the fixed-side die A becomes substantially equal to the thickness of the wood after the compression. Therefore, the cutting is further easily performed and the fiber of the wood is easily cut.

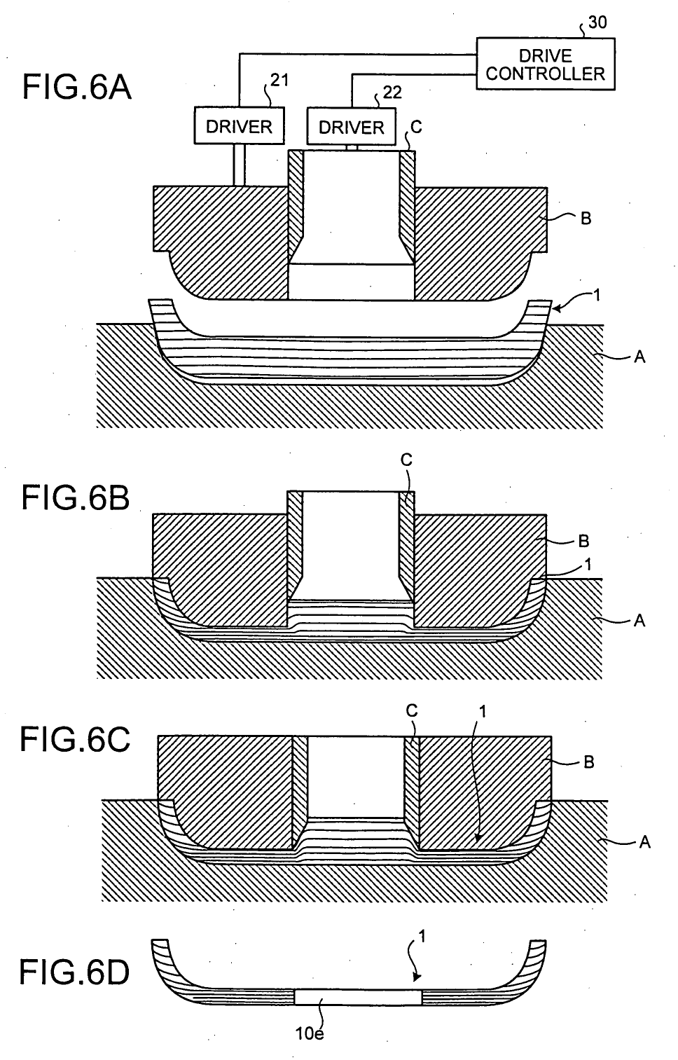

As shown in FIG. 6, it is also possible that the punch C is moved after the compression forming performed by the moving-side die B is completed. Even in this case, since the wood which is the object to be cut is not compressed, the punching can be easily and accurately performed.

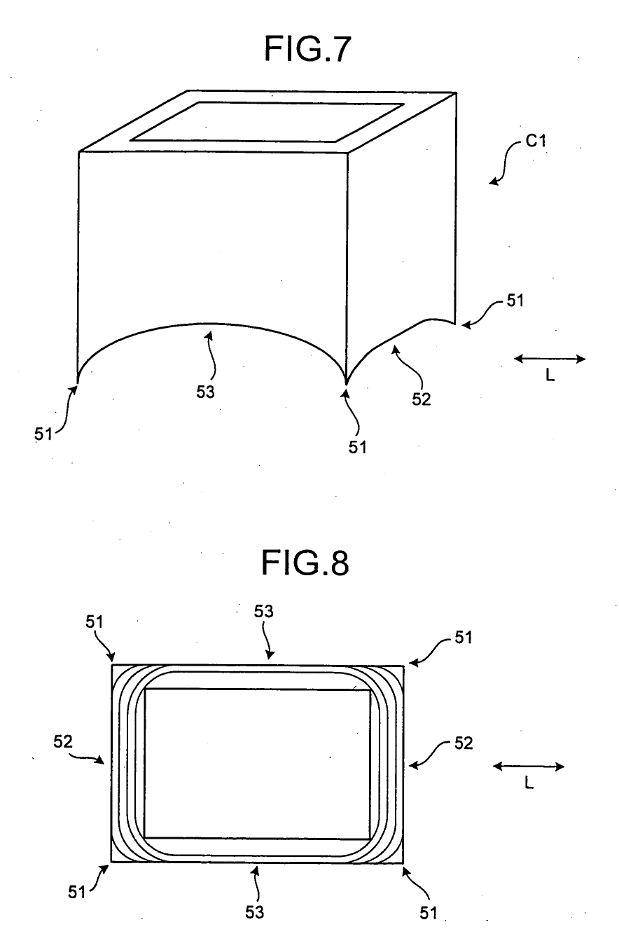

In this case, the description of the embodiment is given on the assumption that the blade portion C1 of the punch C has the substantially flat shape at the leading end portion. However, as shown in FIGS. 7 and 8, the fiber can be further easily cut by adjusting the height of the leading end portions. FIG. 7 is a perspective view that depicts schematically the blade portion C1 of the punch C. FIG. 8 is a bottom view of the blade portion C1 of the punch C, and an altitude is schematically shown by a contour line. As described above, the sectional shape of the punch C is rectangular corresponding to the window 10e. A corner portion 51 of the blade portion C1 is projected furthest, a side portion 52 which is located between the corner portions 51 and orthogonal to the fiber direction L forms a gentle concave portion, and a side portion 53 which is located between the corner portions 51 and parallel to the fiber direction L also forms a gentle concave portion. However, the blade portion in the side portion 52 is projected further than the blade portion in the side portion 53. This is because the side portion 52 cuts the fiber of the wood 1 prior to the side portion 53. The reason why the corner portion 51 is projected furthest is that the corner portion 51 cuts first the fiber of the wood 1 in order to eliminate stress which concentrates on corner portions of the wood to be punched.

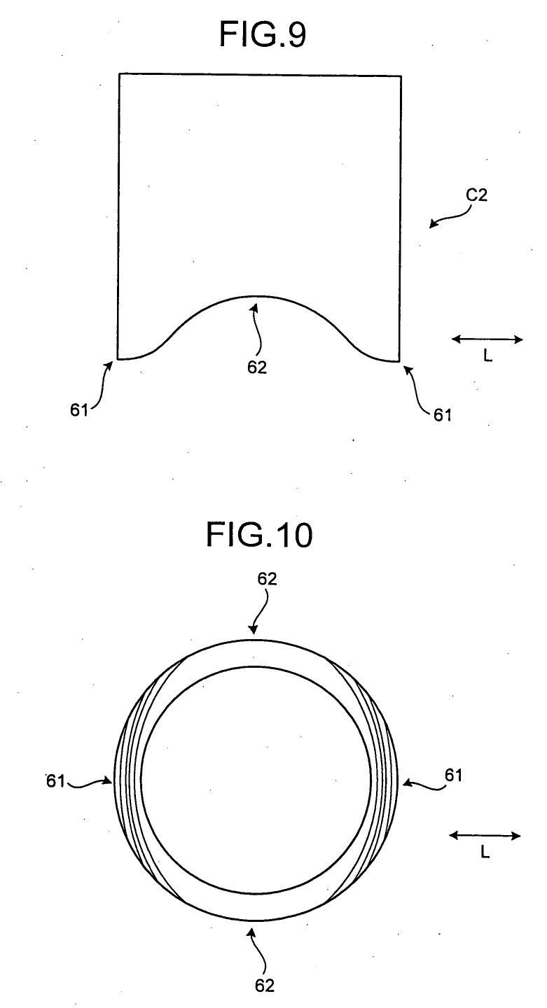

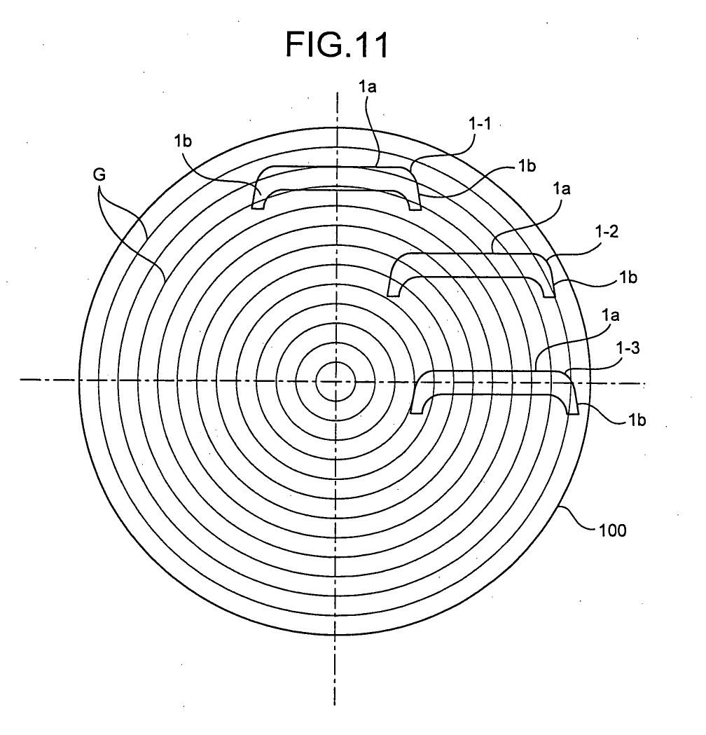

When the circular hole such as the lens hole 10c is punched, it is preferable that a blade portion C2 of the punch C has the shape shown in FIGS. 9 and 10. FIG. 9 is a front elevation of the blade portion C2 of the punch C. FIG. 10 is a bottom view of the blade portion C2 of the punch C, and the altitude of the blade portion C2 is schematically shown by the contour line. As shown in FIGS. 9 and 10, the leading end portion orthogonal to the fiber direction L of the wood 1 is projected furthest, and the leading end portion of the part of the blade portion C2 parallel to the fiber direction L is projected least. Therefore, as with the blade portion C1 shown in FIGS. 7 and 8, the fiber of the wood can be further easily cut and the fiber can be cut with high accuracy.

As shown in FIG. 11, there are three modes in which the shape of the wood 1 is taken from the raw material 100, namely a wood 1-1, a wood 1-2, and a wood 1-3. The wood 1-1 is identical to the wood 1, where the pieces of grain G exist in a lamellar shape within a plate thickness of the main plate portion 1a, and the shape of the main plate portion 1a is taken while the surface revealing itself in the thickness direction has the flat grain. In the wood 1-2, the pieces of grain G exist in an obliquely lamellar shape within the plate thickness of the main plate portion 1a, and the shape of the main plate portion 1a is taken while the surface revealing itself in the thickness direction has an intermediate grain between the flat grain and an edge grain. In the wood 1-3, the pieces of grain G exist in the lamellar shape in direction perpendicular to the plate thickness of the main plate portion 1a, and the shape of the main plate portion 1a is taken while the surface revealing itself in the thickness direction has the edge grain. In each case, the fiber directions of the wood 1-1 to 1-3 are similar to one another, so that the forming apparatus can effectively be utilized.

Then, a second embodiment of the invention is explained. The compressed wood to which the punching has been performed is formed in the first embodiment. On the other hand, the compressed wood to which the blanking has been performed is formed in the second embodiment.

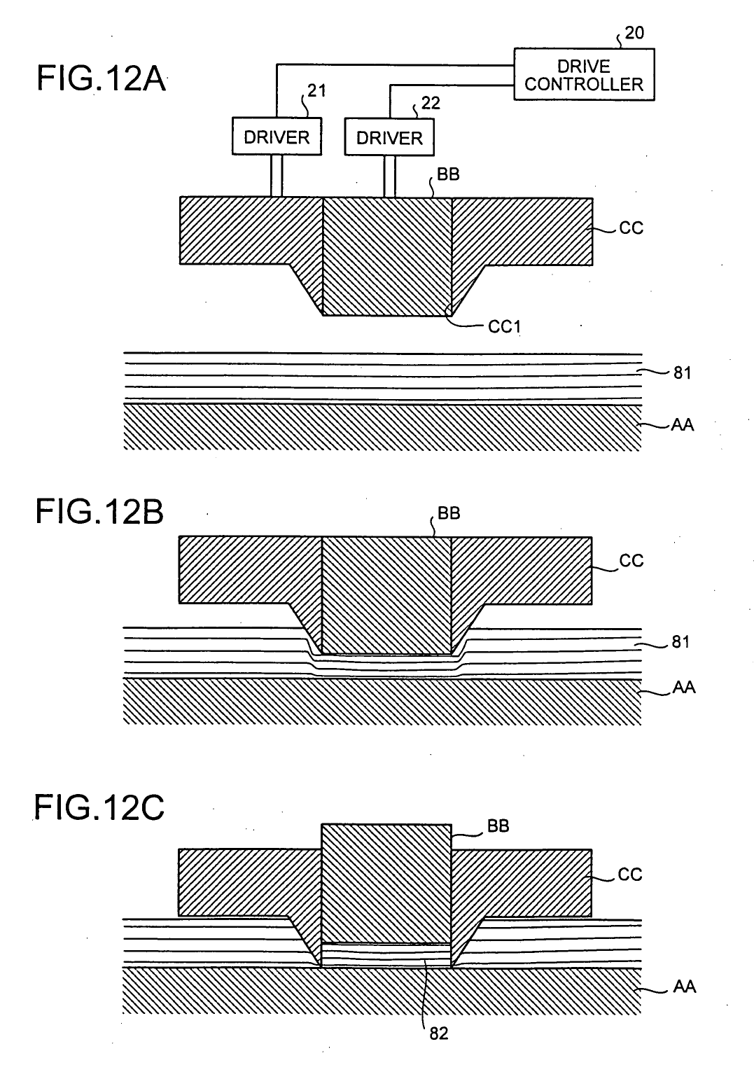

FIG. 12 shows a process of performing the compression and the blanking with a forming apparatus according to the second embodiment of the invention. Unlike the forming apparatus shown in FIG. 3, in the forming apparatus shown in FIG. 12, a punch CC comparable to the punch C is provided outside a moving-side die BB comparable to the moving-side die B, and the compression forming is performed with the moving-side die BB and a fixed-side die AA while the blanking is performed with the punch CC. A guide hole CC1 that guides the moving-side die BB is provided in the punch CC. The moving-side die BB and the punch CC are simultaneously lowered like the forming apparatus shown in FIG. 3 and, after the process of compressing a wood 81 is completed, the punch CC cuts the remaining wood off to form a compressed wood 82 which has been blanked.

Even in the second embodiment, since the wood which is the object to be cut is not compressed during the blanking, the cutting can be easily performed, and the forming can be realized with high accuracy. As with the first embodiment, the blade portion located on the side orthogonal to the fiber direction is projected further to cut first the fiber, which allows the cutting to be further easily performed with high accuracy. In the first and second embodiments, the blade portions which have the rectangular and circular shapes are shown as examples. However, the shape of the blade portion is not limited to the first and second embodiments. For example, it is also possible that the blade portion has other shapes such as an oval shape. In this case, as described above, it is preferable that the blade portion of the part orthogonal to the fiber direction of the wood is formed in the projected shape.

In the first and second embodiments, the moving-side die B (BB) is moved toward the fixed-side die A (AA) to perform the compression forming. However, the invention is not limited to the first and second embodiments. For example, it is possible that the die comparable to the fixed-side die A (AA) is moved toward the die comparable to the moving-side die B (BB) to perform the compression forming. Namely, the actions of the fixed-side die A (AA) and the moving-side die B (BB) are reversed, the punch C (CC) is provided on the fixed die, and the forming processes such as the punching and the blanking can be performed by relatively bringing the punch C (CC) close to the moving die.

When the forming process such as the punching or the blanking is performed to the compressed wood, there may be sometimes problems that a crack and the like caused by anisotropic properties of the wood are generated in the cut portion after processing along the fiber direction and the processing cannot be performed with high accuracy, because the strength of the compressed wood is high due to compression, and moreover, the cutting strength is varied depending on the fiber direction of the wood. The problem that the compressed wood is hardly applied to the electronic equipment to which high accuracy is required is also generated, unless the processing can be performed with high accuracy. However, in the embodiments explained above, the cutting of the compressed wood can be easily and accurately performed in the invention, so that the invention is preferable to the forming apparatus that performs the punching or the blanking to the compressed wood.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A forming apparatus comprising:
a punching unit that punches a wood of a formed object in a predetermined shape;
a first die that has a guide hole for guiding the punching unit and performs compression forming of the wood;
a second die that forms a pair with the first die to perform the compression forming of the wood; and
a drive controller that relatively brings the punching unit close to the second die to punch the wood in the predetermined shape while moving one of the first die and the second die toward the other one of the first die and the second die to perform the compression forming of the wood.

2. The forming apparatus according to claim 1, wherein the drive controller relatively brings the punching unit close to the second die subsequent to one of the first die and the second die to punch the wood in the predetermined shape while moving one of the first die and the second die toward the other one of the first die and the second die to perform the compression forming of the wood.

3. The forming apparatus according to claim 1, wherein the drive controller relatively brings the punching unit close to the second die to punch the wood in the predetermined shape after moving one of the first die and the second die toward the other one of the first die and the second die to perform the compression forming of the wood.

4. The forming apparatus according to claim 1, wherein the drive controller makes moving speed of the punching unit faster than the moving speed of one of the first die and the second die during the compression of the wood to punch the wood in the predetermined shape.

5. The forming, apparatus according to claim 1, wherein, in a leading end blade of the punching unit, a blade area that is substantially orthogonal to a fiber direction of the wood during the movement of the punching unit is totally projected toward a moving direction further than other blade areas.

6. The forming apparatus according to claim 1, wherein the leading end blade of the punching unit has a substantially rectangular shape, the blade area that is substantially orthogonal to the fiber direction of the wood during the movement of the punching unit is totally projected toward the moving direction further than the blade area that is substantially parallel to the fiber direction, and corner portions which are located at both ends of the projection are projected furthest.

7. The forming apparatus according to claim 6, wherein the blade area that is substantially orthogonal to the fiber direction has an arch shape that forms a concave portion smoothly toward a central portion of the blade area.

8. The forming apparatus according to claim 1, wherein the leading end blade of the punching unit has a substantially circular shape or a substantially oval shape, the blade area that is substantially orthogonal to the fiber direction of the wood during the movement of the punching unit is totally projected toward the moving direction further than the blade area that is substantially parallel to the fiber direction, and the blade area that is most orthogonal to the fiber direction is projected furthest.

9. The forming apparatus according to claim 8, wherein the leading end blade of the punching unit is gently inclined from the blade area that is most orthogonal to the fiber direction toward the blade area that is substantially parallel to the fiber direction.

10. A forming apparatus comprising:
a first die that performs compression forming of a wood of a formed object;
a punching unit that is guided along a periphery of the first die and blanks the wood in a predetermined shape;
a second die that forms a pair with the first die to perform the compression forming of the wood; and
a drive controller that relatively brings the punching unit close to the second die to blank the wood in the predetermined shape while moving one of the first die and the second die toward the other one of the first die and the second die to perform the compression forming of the wood.

11. The forming apparatus according to claim 10, wherein the drive controller relatively brings the punching unit close to the second die subsequent to one of the first die and the second die to blank the wood in the predetermined shape while moving one of the first die and the second die toward the other one of the first die and the second die to perform the compression forming of the wood.

12. The forming apparatus according to claim 10, wherein the drive controller relatively brings the punching unit close to the second die to blank the wood in the predetermined shape after moving one of the first die and the second die toward the other one of the first die and the second die to perform the compression forming of the wood.

13. The forming apparatus according to claim 10, wherein the drive controller makes moving speed of the punching unit faster than the moving speed of one of the first die and the second die during the compression of the wood to blank the wood in the predetermined shape.

14. The forming apparatus according to claim 10, wherein, in a leading end blade of the punching unit, a blade area that is substantially orthogonal to a fiber direction of the wood during the movement of the punching unit is totally projected toward a moving direction further than other blade areas.

15. The forming apparatus according to claim 10, wherein the leading end blade of the punching unit has a substantially rectangular shape, the blade area that is substantially orthogonal to the fiber direction of the wood during the movement of the punching unit is totally projected toward the moving direction further than the blade area that is substantially parallel to the fiber direction, and corner portions that are located at both ends of the projection are projected furthest.

16. The forming apparatus according to claim 15, wherein the blade area that is substantially orthogonal to the fiber direction has an arch shape that forms a concave portion smoothly toward a central portion of the blade area.

17. The forming apparatus according to claim 10, wherein the leading end blade of the punching unit has a substantially circular shape or a substantially oval shape, the blade area that is substantially orthogonal to the fiber direction of the wood during the movement of the punching unit is totally projected toward the moving direction further than the blade area that is substantially parallel to the fiber direction, and the blade area that is most orthogonal to the fiber direction is projected furthest.

18. The forming apparatus according to claim 17, wherein the leading end blade of the punching unit is gently inclined from the blade portion that is most orthogonal to the fiber direction toward the blade area that is substantially parallel to the fiber direction.
